(19) United States
(12) Patent Application Publication
(10) Pub. No.: US 2006/0222740 A1
(43) Pub. Date: Oct. 5, 2006

(54) Food product

(76) Inventors: Chai Yen Kao, Singapore (SG); Nyok Joo Wong, Singapora (SG); Boon Keng Leow, Singapore (SG); May Wei Koh, Singapore (SG); Soon Keat Oon, Minhang Dist. Shanghai (CN); Ralph Trksak, Manville, NJ (US)

Correspondence Address: NATIONAL STARCH AND CHEMICAL COMPANY, P.O. BOX 6500, BRIDGEWATER, NJ, 08807-3300, US

(21) Appl. No.: 11/395,767

(22) Filed: Mar. 31, 2006

(30) Foreign Application Priority Data
Apr. 4, 2005 (SG) 200502033-4

(51) Int. Cl. A21D 13/00

(52) U.S. Cl. 426/94

(57) ABSTRACT

This invention pertains to a baked product comprising rice flour, pregelatinised rice starch, and optionally modified rice starch. Such products have good acceptability in internal and external properties and appearance, similar to that of wheat flour containing baked products.

This application claims priority under 35 U.S.C. § 119 of Singapore Patent Application No 200502033-4 filed 4 Apr. 2005.

### FIELD OF THE INVENTION

The invention relates to food products that are gluten-free, and more particular, to a gluten-free dough and the method of producing the same.

### BACKGROUND

Any discussion of the prior art throughout the specification should in no way be considered as an admission that such prior art is widely known or forms part of common general knowledge in the field.

Celiac disease is a lifelong digestive disorder, found in individuals who are genetically susceptible, that results in damage to the small intestine by interfering with the absorption of nutrients. Celiac disease is unique in that a specific food component, gluten, has been identified as the culprit. Gluten is the common name for the offending proteins in specific cereal grains that are harmful to persons with this disease. These proteins are found in all forms of wheat (including durum, semolina, spelt, kamut, einkorn, and faro), and related grains, rye, barley, and triticale. Damage to the mucosal surface of the small intestine is caused by an immunologically toxic reaction to the ingestion of gluten. Symptoms of celiac disease can range from the classic features, such as diarrhoea, weight loss, and malnutrition, to latent symptoms such as isolated nutrient deficiencies but no gastrointestinal symptoms. The disease mostly affects people of European (especially Northern European) descent, but recent studies show that it also affects Hispanic, Black and Asian populations as well. Those affected suffer damage to the villi (shortening and villous flattening) in the lamina propria and crypt regions of their intestines when they eat specific food-grain antigens (toxic amino acid sequences) that are found in wheat, rye, and barley. Oats have traditionally been considered to be toxic to celiacs, but recent scientific studies have shown otherwise. This research is ongoing, however, and it may be too early to draw solid conclusions.

Because of the broad range of symptoms celiac disease presents, it can be difficult to diagnose. (New England Journal of Medicine, May 2, 1996—Volume 334, Number 18, “The Many Faces of Celiac Disease” by Charles H. Halsted, M D). If a person with the disorder continues to eat gluten, studies have shown that he or she will increase their chances of gastrointestinal cancer by a factor of 40 to 100 times that of the normal population. Further, “gastrointestinal carcinoma or lymphoma develops in up to 15 percent of patients with untreated or refractory celiac disease.” (Goggins, et. al. “Celiac Disease and Other Nutrient Related Injuries to the Gastrointestinal Tract” The American Journal of Gastroenterology. Vol. 89, No. 8, pages S2-S13, 1994). It is therefore imperative that the disease is quickly and properly diagnosed so it can be treated as soon as possible.

The only acceptable treatment for celiac disease is strict adherence to a 100% gluten-free diet for life. An adherence to a gluten-free diet can prevent almost all complications caused by the disease. A gluten-free diet means avoiding all products that contain wheat, rye and barley, or any of their derivatives. This is a difficult task as there are many hidden sources of gluten found in the ingredients of many processed foods.

Many investigators have attempted to develop gluten-free, non-wheat cereal products. Rice flour is useful since it lacks gluten and contains low levels of sodium and a high amount of easily digested carbohydrates, making it desirable to celiac diets. It has many unique attributes, such as ease of digestion, bland taste, and hypoallergenic properties.

There have been attempts to produce gluten-free bread (Kulp and others 1974), which might more closely resemble conventional whole wheat bread. Recent availability of household bread machines has made it possible to easily custom bake various breads at home. Rice bread made with a recommended recipe in a home breadmaker can yield a crumbly, dry, fluffy, but poor-flavoured bread. Adding small amounts of defatted bran can improve both texture and flavour. The final baked bread may be in many respects comparable to whole-wheat bread. However, the bread can still tend to retrograde and become crumbly within a few days during storage at refrigerated (4° C.) temperature. Earlier rice breads (Nishita and others 1976) were also reported to have a very short shelf-life.

Therefore, there are still a number of problems associated with producing baked rice products. Without gluten and the inability of rice flour to form a gel, the final baked products using rice flour formulations such as bread, buns and cookies have undesirable volume, crumb character, grain, texture, appearance and eating quality. This is due to the extremely small size and nature of the starch granules and the inability of the protein to form a structural network. These problems increase where wheat flour is completely replaced with rice flour. No formulation exists for producing a 100% rice flour food product that is not dense or gummy and which has good grain, texture, appearance and eating quality.

It is also known to make non-wheat baked products e.g. bread, by replacing the gluten structure of wheat by gluten substitutes having binding functions and film forming properties to retain gas bubbles such as xanthan gum, carboxy methyl cellulose (CMC), hydroxy propyl methyl cellulose (HPMC), hydrocolloids or surfactants (Kent's Technology Of Cereals, Fourth Edition, N. L. Kent and A. D. Evers, Pergamon, p. 215). However, these added components have a tendency to provide a chewy and non-crispy texture.

Therefore, there is a need to provide a gluten-free food product that has good acceptability in internal and external properties and has identical appearance to wheat-flour (gluten containing) products. In particular, there is a need to provide a dough that can be processed with typical breadmaking procedures and equipment. It should also provide a more natural tasting product than commercially available. The combination of ingredients should impart better dough forming ability and unique final product texture ideally without the usage of gums such as xanthan, CMC, etc or wheat gluten. However, it will be appreciated that even if gums are not required to achieve good dough forming ability, they can nevertheless always be added if it is desired to modify the formulation.

It is an object of the present invention to overcome or ameliorate at least one of the disadvantages of the prior art, or to provide a useful alternative.

### SUMMARY OF THE INVENTION

According to a first aspect of the invention, there is provided a flour/starch mixture comprising:

(a) rice flour; and

(b) pregelatinised rice starch

The flour/starch mixtures of the present invention may also contain a modified rice starch.

According to a second aspect of the invention, there is provided a flour/starch mixture comprising:

(a) rice flour;

(b) pregelatinised rice starch; and

(c) modified rice starch.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

In addition to pregelatinised rice starch, other cooked-up rice starches may be used.

In some embodiments of the invention the flour/starch mixtures are gluten free.

Preferably, the flour/starch mixture of the present invention is capable of forming a dough. More preferably, the dough is a bread dough, cake dough, cookie dough or biscuit dough. Preferably, the dough is capable of containing air cells produced by any leavening agent, and can be processed using conventional methods available to wheat products, for instance, mixed, fermented, scaled, moulded, proofed and cooked (eg baked, fried, steamed etc.) like conventional gluten containing products.

Preferably, the flour/starch mixtures, doughs and baked products of the present invention are free from gums. Preferably, they contain no or low amounts of non-rice starch. For example, the products of the present invention may be substantially free of potato starch, tapioca starch, maize starch etc.

Percentages mentioned here will be stated in “baker's percentage”, and “true percentage”. “Baker's percentage” will be used unless stated otherwise. In “baker's percentage”, which is a well known term in the art, the amount of the flour/starch mixture is standardised at 100%, and the quantities of other components relative to the flour starch mixture are also given in terms of percentages.

Preferably, the flour/starch mixture comprises rice flour in an amount of 10 to 90%, more preferably 20 to 85% and even more preferably 55 to 65%.

Preferably, the flour/starch mixture comprises pregelatinised rice starch in an amount of 5-50%, more preferably 10 to 45% and even more preferably 20 to 25%.

Preferably, the flour/starch mixture comprises modified rice starch in an amount of 0 to 40%, more preferably 5-35% and even more preferably 10 to 15%.

In one preferred embodiment of the flour/starch mixture, the rice flour is present in an amount of 20-85%, the pregelatinised rice starch is present in an amount of 10 to 45% and the modified rice starch is present in an amount of 5-35%, where the total amount of rice flour, pregelatinised rice starch and modified rice starch is 100%.

In a further preferred embodiment of the flour/starch mixture, the rice flour is present in an amount of 55-65%, the pregelatinised rice starch is present in an amount of 20-25% and the modified rice starch is present in an amount of 10-15%, where the total amount of rice flour, pregelatinised rice starch and modified rice starch is 100%.

According to a third aspect, the invention provides a dough comprising a flour/starch mixture of the first or second aspects and further comprising other ingredients. The other ingredients are preferably selected to modify taste, texture, smell, appearance, keeping properties, workability, cooking properties, nutritional balance and the like. Particularly preferred are ingredients such as shortening, salt, sugar, egg, egg powder, milk, milk powder, leavening agents such as yeast, and monoglyceride.

In another embodiment, other ingredients such as shortening, salt, and sugar can be added at 5-15%, 1-3%, and 5-20%, respectively. Whole egg can be added at 7-20%, while skim milk powder at 5-15%. Leavening agent, either yeast or chemical agent, can be added at a suitable amount to provide fermentation, flavour and volume. However, if using dry yeast, recommended level is 0.5-2%. Monoglyceride can be added at 0.1 to 1% to improve dough handling properties.

Further additives may be added to vary the formulation, for example, one or more ingredients such as hydrocolloids, modified starches, enzymes, dextrin, maltodextrin, or other dough improvers. Hydrocolloids may include xanthan, guar gum, locust bean gum, methyl cellulose, hydroxypropyl methyl cellulose, carboxymethyl cellulose (CMC), etc. The levels can range from as low as 1% to 7%, which depends on the property of the specific gum product used. In one embodiment, no hydrocolloid additives are used.

Modified starches can be made from tapioca, waxy corn, corn, waxy rice, rice, wheat, etc. These ingredients provide variation in dough properties and final texture.

Rice flour is used in the present invention as the main constituent of the dough, in a manner similar to the use of wheat flour in bread production. It provides the main carbohydrate source, dominating flavour and texture, etc.

Without wishing to be bound by theory, it is believed that pregelatinised rice starch acts as the dough forming agent. In wheat flour bread, the dough forming agent is wheat gluten. However, when rice flour is used rather than wheat flour, no gluten is present. Rice protein does not have the capability to form a cohesive dough. Surprisingly, the present inventors have found that pregelatinised rice starch, when used in rice flour, is capable of conferring this property onto the dough.

Modified rice starch may used to modify final properties of the bread, particularly the crumbs. For example, some benefits modified rice starch may offer are higher moistness, softer crumb, longer shelf life, etc.

The overall invention overcomes the difficulties of making bread without wheat flour, which contains wheat gluten (the main dough forming agent in bread products). The solution offered is the use of rice flour and pregelatinised rice starch, in some cases in combination with modified rice starch to overcome the known shortcomings of making a rice flour bread (processing difficulties and product deficiencies in areas such as taste, texture and keepability for instance).

The rice flour can come from any commercially available source. It is preferred to have rice flour with amylose, rather than with none. It is more preferable to have rice flour with at least 10% amylose. Indica is also preferred. Common rice flour contains approximately 15-25% amylose. Rice flour is prepared from rice grain. Rice from the field is cleaned and de-husked/de-hulled, and polished to remove bran. The amount of bran removed will affect nutritional content of the final rice flour (fat, protein, fibres, etc) and also the final color of the flour (slightly yellow to white). Any level of rice bran is acceptable in the present invention. The rice grain can go through two types of milling, wet or dry milling. In wet milling, the rice grain is soaked in water. The soaked grain is run through the milling machine together with extra amount of water. The milling mechanism is a crushing and grinding one, where the grain is reduced to flour particle size. The water-flour mixture is filtered, dried and packed. In dry milling, rice grain is not introduced to water. It goes directly into the milling machine, and is crushed into its final particle size. Any form of milling is acceptable in the present invention. Rice used in the preferred embodiments of the present invention was obtained from the commercial market.

Pregelatinised rice starch can be prepared from a rice starch, which contains any range of amylose/amylopectin or gelatinisation temperature. The starch will be mixed with water into a slurry of a certain solids content. The slurry is then added on top of a hot rotating drum. As the material is heated on the drum, two events happen, namely cooking or swelling of the starch, and then subsequent drying of the material through water evaporation. The final function of the pregelatinised rice starch determines how it is processed on the drum. Factors such as solids content, gelatinisation temperature of the starch, drum temperature and rotating speed, can all affect the final texture of the pregelatinised rice starch. Those of ordinary skill in the art of drum drying would know what parameters to adjust in order to get the desired final performance of the pregelatinised rice starch. For example, one rice starch may have a low gelatinisation temperature, another may have a high gelatinisation temperature. If both are processed through the same set of drum drying conditions, one may have a good performance in the rice bun dough, whereas the other may give an overly tough dough and may result in a drier crumb. In the case of the unsatisfactory starch, it may be possible that the starch was undercooked on the drum, and therefore the solution might be to increase the drum dying temperature, slow the drum speed, or decrease the slurry solids, among others. Such variations would be well within the skill of those familiar with drum drying to pregelatinise starch. Besides drum drying, other known techniques used to prepare pregelatinized starches include jet cooking and spray drying.

Pregelatinised starch is distinct from other forms of modified starch, such as hydrolysed starch. Modified starch can be in pregelatinised form. There are various types of possible modifications. Hydroxypropyl waxy rice starch work best in maintaining quality and texture of the final baked products.

There are numerous ways to chemically modify a starch. For example, starch can be treated with chemicals so that some hydroxyl groups on the starch are replaced by either ester or ether groups. Crosslinking, in which two hydroxyl groups on neighbouring starch molecules are chemically linked, is also a form of chemical modification. Very low levels of chemical modification can significantly change the rheological, physical, and chemical properties of starch. Chemically modified starch for use in foodstuffs is restricted in range and level of modification by various legislative bodies. Chemically modified starches include crosslinked starches, acetylated and organically esterified starches, hydroxyethylated and hydroxypropylated starches, phosphorylated and inorganically esterified starches, anionic and nonionic starches, and succinate and substituted succinate derivatives of starch. [Modified Starches: Properties and Uses, Ed. Wurzburg, CRC Press, Inc., Florida (1986).] The starch may be pregelatinized, making it cold-water dispersible. Various techniques known in the art, including drum drying, spray drying, or jet cooking can pregelatinise these starches. Exemplary processes for preparing pregelatinised starches are disclosed in U.S. Pat. Nos. 1,516,512; 1,901,109;2,314,459; 2,582,198; 2,805,966; 2,919,214; 2,940,876; 3,086,890; 3,133,836; 3,137,592; 3,234,046; 3,607,394; 3,630,775; 4,280,851; 4,465,702; 5,037,929; 5,131,953, and 5,149,799.

The chemically modified starches can include any starch source, whether rice or others. The modification is done by chemical addition at desired levels and in one embodiment is by levels allowed by regulatory agencies such as those described in the US Code of Federal Regulations definitions. Theoretically, modified starches made from corn and wheat would not contain gluten because the process of starch extraction removes gluten and any other components in the original grain/starch source. One can always argue there are always trace amount of gluten in wheat starch. The “gluten” contained in corn is technically of a different molecular make-up than that in wheat. Most allergic reaction to gluten occurs from a wheat source, at a substantial dose. The World Health Organisation states that gluten-free foods should contain less than 1 mg gliadin per 100-g product. So for the purposes of the present invention, gluten free encompasses not only those materials which have zero gluten detectable by any means, but also encompasses those levels of gluten which are so low as to cause no identifiable risk to humans and in one aspect of the invention less than 1 mg gliadin per 100 g product.

By “proofing”, is meant the time required for yeast in a dough to produce sufficient amount of carbon dioxide gas to give desired height, volume and structure in a baked product.

By “dough”, is meant a mixture of flour/starch and other ingredients firm enough to knead or roll. In addition, it also refers to the cohesive product that results from the mixture, after subsequent proofing, of flour and/or starch, water along with possibly fats and other usual ingredients normally entering the composition of a usual dough such as salt, yeast or chemical leavening agents, fibres, egg proteins, milk proteins and sugar.

By “baked product”, is meant any product prepared from a dough, either of a soft or a crisp character. Examples of baked products, whether of a white, light or dark type, which may be advantageously produced by the present invention include without limitation buns, cookies, biscuits, donuts, crackers, muffins, cakes, bread and rolls.

The handling of the dough and/or baking may be performed in any suitable manner for the dough and/or baked product in question, typically including the steps of kneading the dough, subjecting the dough to one or more proofing treatments, and baking the product under suitable conditions, i.e. at a suitable temperature and for a sufficient period of time. For instance, the dough may be prepared by using conventional methods such as a normal straight dough process, a sour dough process, an overnight dough method, a low-temperature and long-time fermentation method, a frozen dough method, the Chorleywood Bread process, or the Sponge and Dough process.

From the above disclosure, it will be apparent that the dough of the invention is generally a leavened dough or a dough to be subjected to leavening. The dough may be leavened in various ways such as by adding sodium bicarbonate, monocalcium phosphate, sodium stearoyl lactylate, ammonium bicarbonate or the like, or by adding a leaven (fermenting dough). Addition of chemical leavening agents is common in a wide range of bakery products such as cakes, muffins and the like. Such agents are also used in combination with leavening acids such as sodium acid pyrophosphate, monocalcium phosphate monohydrate, monocalcium phosphate anhydrous, sodium aluminium phosphate acidic, dicalcium and phosphate dihyrate. However, it is preferable that the dough be leavened by adding a suitable yeast culture, such as a culture of Saccharomyces cerevisiae (baker's yeast). Any of the commercially available Saccharomyces cerevisiae strains may be employed. The dough may also be an unleavened dough.

Preferred fat used in the dough recipes is selected from the group consisting of solid shortenings or oil. Preferred shortening compositions include margarine, butter fat or lard. Oils may include vegetable or animal oils. Vegetable oils are preferred such as rapeseed, corn, peanut, palm, palm-kernel, sesame, soybean, sunflower or olive oil. Unlike conventional cookies, recipes for buns typically use fat as shortenings.

According to a fourth aspect, the invention provides a methods for preparing a baked product, comprising baking a dough of the present invention to produce a baked product. The baking of the dough to produce a baked product may be performed using methods well known in the art. Preferably, the methods require no modification from those used to prepare wheat based baked products.

According to a fifth aspect, the present invention relates to gluten-free baked products, produced from the flour/starch mixtures and doughs of the present invention.

The gluten-free baked products include, without limitation, breads, cakes, cookies, biscuits, bagels, muffins, toasts, crackers, pizza crusts, brownies, croissants, pastries, croutons, wafers, snack foods, crisps, waffles etc.

The advantages of the present invention include providing an all-rice, gluten-free food product that is more natural tasting. The combination of the ingredients impart better dough forming ability and unique final product texture through the use of starch-based materials rather than the usage of gums such as xanthan or carboxymethyl cellulose (CMC) or wheat gluten.

The following embodiments are presented to further illustrate and explain the present invention and should not be taken as limiting in any regard.
1. A gluten-free flour/starch mixture comprising:
   (a) rice flour; and
   (b) pregelatinised rice starch
2. A gluten-free flour/starch mixture comprising:
   (a) rice flour;
   (b) pregelatinised rice starch; and
   (c) modified rice starch
3. A flour/starch mixture comprising:
   (a) rice flour; and
   (b) pregelatinised rice starch
4. A flour/starch mixture comprising:
   (c) rice flour;
   (d) pregelatinised rice starch; and
   (e) modified rice starch.
5. A flour/starch mixture according to any one of embodiments 1 to 4 for use in a dough.
6. A flour/starch mixture according to any one of embodiments 1 to 4 wherein the rice flour is present in an amount of about 20% to about 80% by weight.
7. A flour/starch mixture according to any one of embodiments 1 to 4 wherein the pregelatinised rice starch is present in an amount of about 10% to about 40% by weight.
8. A flour/starch mixture according to any one of embodiments 2, 4, 5, 6 or 7, wherein the modified rice starch is present in an amount of about 5% to about 30% by weight.
9. A flour/starch mixture according to embodiment 1 or 3, wherein the rice flour and pregelatinised rice starch are present in an amount of 20% to 80% and 10% to 40% by weight respectively.
10. A flour/starch mixture according to embodiment 2 or 4, wherein the rice flour, pregelatinised rice starch and modified rice starch are present in an amount of 20% to 80%, 10% to 40% and 5% to 30% by weight respectively.
11. A flour/starch mixture according to any one of embodiments 1-10, wherein the rice flour is present in an amount of about 55% to about 65% by weight.
12. A flour/starch mixture according to any one of embodiments 1-11, wherein the pregelatinised rice starch is present in an amount of about 20% to about 25% by weight.
13. A flour/starch mixture according to embodiment 2 or 4, wherein the modified rice starch is present in an amount of about 10% to about 15% by weight.
14. A flour/starch mixture according to embodiment 2 or 4, wherein the rice flour, pregelatinised rice starch and modified rice starch are present in an amount of 55% to 65%, 20% to 25% and 10% to 15% by weight. respectively.
15. A dough comprising a mixture according to any one of embodiments 1-14.
16. A dough comprising a mixture according to any one of embodiments 1-15 without the presence of non-rice based flour or starch.
17. A dough comprising a gluten-free flour/starch mixture according to any one of embodiments 1 to 14 and further comprising at least one ingredient selected from the group consisting of water, a leavening agent, salt, sugar, icing sugar, eggs, skim milk powder, baking powder, monoglycerides, a fat source and a flavouring.
18. A dough comprising a gluten-free flour/starch mixture according to any one of embodiments 1 to 14 and without comprising hydrocolloid additives.
19. A dough according to embodiment 17, wherein the leavening agent is a chemical leavening agent.
20. A dough according to embodiment 19, wherein the chemical leavening agent is selected from the group consisting of sodium bicarbonate, monocalcium phosphate (MCP), Sodium stearoyl lactylate (SSL) and ammonium bicarbonate.
21. A dough according to embodiment 20, further comprising at least one acid ingredient selected from the group consisting of sodium acid pyrophosphate, monocalcium phosphate monohydrate, monocalcium phosphate anhydrous, sodium aluminium phosphate acidic, dicalcium and phosphate dihyrate.
22. A dough according to embodiment 17, wherein the leavening agent is yeast.
23. A dough according to embodiment 22, wherein the yeast is in the form of dry instant yeast.
24. A dough according to embodiment 23, wherein the dry instant yeast is present in an amount of about 0.87% by weight.
25. A dough according to any one of embodiments 1-24, wherein the pregelatinised rice starch is modified chemically.
26. A dough according to any one of embodiments 15 to 25, wherein the dough is shaped into the form of a bun.
27. A dough according to any one of embodiments 15 to 25, wherein the dough is shaped into the form of a cookie.
28. A method of making a dough comprising the steps of:
   (a) combining the mixture according to any one of embodiments 1 to 14 with water; and
   (b) fermenting the dough.
29. A method according to embodiment 28 further comprising the steps of
   (a) punching the dough and shaping the dough to form a shaped dough; and
   (b) proofing the dough.
30. A method for preparing a baked product comprising baking a gluten-free dough according to any one of embodiments 15 to 27.
31. A dough product obtained by the method of embodiments 28 or 29.
32. A baked product comprising:
   (a) rice flour; and
   (b) pregelatinised rice starch.
33. A baked product comprising:
   (a) rice flour;
   (b) pregelatinised rice starch; and
   (c) modified rice starch.
34. A baked product prepared from a mixture of any one of embodiments 1 to 14 or prepared from a dough of any one of embodiments 15 to 29.
35. A baked product produced by the method of any one of embodiments 28 to 30.
36. A baked product according to any one of embodiments 32 to 35, wherein the product is selected from the group consisting of a bun, a cookie, a biscuit, a donut, a cracker, a muffin, a cake, a bread and a roll.

Further objects and advantages of the invention will be evident from the following description wherein parts and percentages are by weight unless otherwise specified.

### EXAMPLE 1

All-Rice Sweet Bun Formulation

| | Baker's % |
|---|---|
| Rice flour | 61.81 |
| Pregelatinized rice starch | 28.19 |
| Modified rice starch | 10 |
| Skim milk powder | 7 |
| Shortening | 13 |
| Salt | 1.5 |
| Sugar | 15 |
| Whole egg | 10.82 |
| Dry instant yeast | 0.87 |
| Monoglyceride | 0.5 |
| Water | 57.57 |
| TOTAL | 206.26 |

Procedure

Dry ingredients were mixed together in a mixer at slow speed, and shortening was added. Liquid was heated up to 30° C. and slowly added to the mixture. Mixing speed was increased for 1 minute to medium setting, and continued for another 2.5 minutes at slow speed. The dough was allowed to ferment at 30° C. for 1.5 hours. The dough was punched down and moulded into small bun shape. The dough was proofed in the proofing box at 38° C. for 40 min, baked at 180° C. for 20 minutes and taken out of the oven and cooled down.

Results

The resulting product had the cell structure similar to wheat-based bread. The crust was light brown, and the inside was soft and white. When eaten, the texture was soft, slightly chewy and elastic. The sensorial quality was maintained until the day after baking. Staling on the third day resulted in a hard crumb texture.

### EXAMPLE 2

All-Rice Cookie Formulation

| | True % |
|---|---|
| Rice flour | 15 |
| Pregelatinized rice starch | 12 |
| Modified rice starch | 3 |
| Icing sugar | 20 |
| Margarine | 20 |
| Whole egg | 12 |
| Baking powder | 1 |
| Salt | 1 |
| Water | 2 |
| Chocolate powder | 2 |
| Chocolate chips | 12 |
| TOTAL | 100 |

Procedure

The icing sugar was creamed with margarine for about 4-5 minutes (or more) in the mixer at high speed. The egg and water were added and mixed for another 2-3 minutes. All the dry-blended powder components were added in for another 2-3 minutes. The chocolate chips were poured in and mixed for another 1 minute. The cookies were baked at 180° C. for 15 minutes and taken out and cooled.

Results

The cookie had a soft chewy texture. It was not crumbly and was easy to eat/handle. The keeping quality was very good. Chewy texture could still be felt after 2 months storage in room temperature.

### EXAMPLE 3

Green Tea Cookie

Ingredients

| | Baker's % |
|---|---|
| Rice flour* | 49.97 |
| Pregelatinized rice starch | 40.01 |
| Modified rice starch | 10.01 |
| Icing sugar | 66.61 |
| Margarine | 66.61 |
| Whole egg | 40.01 |
| Water | 7.17 |
| Baking powder | 1.66 |
| Salt | 1.30 |
| ^{ex1}Bake-able green tea powder T | 1.30 |
| | (or as required) |
| Black sesame seeds | 8.78 |
| | (or as required) |
| Puffed rice | 8.78 |
| | (or as required) |
| ^{ex2}Green tea flavour | 0.42 |
| | (optional) |
| Total | 302.33% |

*low amylose rice flour is preferred or recommended
^{ex1}Commercially available from Phoon Huat & Company Pte Ltd, Singapore
^{ex2}Tea Green Flavour 428-00156-01 from Givaudan Singapore Pte Ltd, Singapore

Procedure

The icing sugar was sieved to remove lumps. The dry material, with the exception of the icing sugar and puffed rice was blended. The wet ingredients and flavourings were weighed together in a beaker. The margarine was beaten for 1 minute using a Hobart Mixer at speed #2 using the paddle extension. The icing sugar was added consistently over 3 minutes at speed #2. The wet ingredients were added slowly to the mix over two minutes and mixed in the Hobart mixer for 3 minutes at speed #2. The dry ingredients (except for the icing sugar and puffed rice) were added in over 3 minutes at speed #1. The puffed rice was added and mixed for another 1 minute. The dough was flattened to about 0.5 cm thickness and blast frozen for about 10 minutes. The dough was cut to shape and baked at 180° C. for 14 minutes.

The cookie had a soft chewy texture. It was not crumbly and was easy to eat/handle. The keeping quality was very good. Chewy texture could still be felt after 2 months storage in room temperature.

### EXAMPLE 4

Rice Bun Formulation Containing Wheat Gluten

Ingredients

Baker's %

Part A

| | |
|---|---|
| Rice flour | 68 |
| Water (80° C.) | 66.07 |

Part B

| | |
|---|---|
| Wheat gluten | 12 |
| Pregelatinized rice starch | 10 |
| Modified rice starch | 10 |
| Instant yeast | 1.19 |
| ¹Enzyme | 0.08 |
| ²Emusifier | 0.5 |
| ³Emusifier | 0.2 |
| Sugar | 13 |
| Salt | 1 |
| Skim milk powder | 2 |
| Shortening | 10 |
| Baking powder | 2.11 |
| Water (20 C) | 5.31 |
| Total | 201.46 |

¹Sternzym F9023 from Stern-Enzyme GmbH & Co., Germany
²ADMUL SSL 1078 from Quest International, Singapore
³Distilled Monoglyceride from Danisco, Malaysia

Procedure

Water (in Part A) at 80° C. was added slowly to the rice flour using the Horbart Mixer at speed #1 for 3 minutes. The mixture was allowed to rest for 30 minutes. The remaining dry ingredients were weighed into a Horbart Mixer bowl. Mix the dry ingredients for 1 minute at speed #1. The rice flour and water mixture was slowly added into the dry ingredients mixture and mixed at speed #1 for 10 minutes. The shortening was then added and mixed at speed #1 for 3 minutes, followed by speed #2 for 8 minutes. The dough was allowed to rest for 10 minutes. After resting, the dough was cut into smaller pieces, weighing about 75 g each. The pieces of dough were moulded into round shape and allowed to rest for 10 minutes. After that, the pieces of dough smoothened and placed onto the baking tray and allowed to rest for 10 minutes. After 10 minutes, the pieces of dough were flatten and proofed for 70 minutes. After proofing, the pieces of dough were baked at 220/200° C. (upper/bottom) for 14 mins.

### EXAMPLE 5

Rice Bun Formulation Containing Hydrocolloid

Ingredients

| | Baker's % |
|---|---|
| Rice flour | 24 |
| Pregelatinized rice starch | 5 |
| Modified rice starch | 10 |
| Modified rice starch | 13.19 |
| Maltodextrin | 10 |
| Carboxymethylcellulose | 1 |
| Native rice starch | 36.83 |
| Skim milk powder | 7 |
| Shortening | 6.5 |
| Salt | 1.5 |
| Sugar | 10 |
| Whole egg | 10.82 |
| Water | 54.47 |
| Distilled monoglyceride | 0.5 |
| Dry yeast | 1.5 |
| Sodium bicarbonate | 0.43 |
| Sodium acid pyrophosphate | 0.43 |
| Total | 193.17 |

alpha amylase: 0.116 g for 350 g of flour

Procedure

The ingredients of all the dry mix were blended together. The shortening was then added into the dry mix and mixed in the Horbart mixer at speed #1 for 2 minutes. The paddle was used to mix the dry mix. The liquid portion was prepared at 30-35° C. and added to the dry mix gradually at speed 1 for 1 minute. The paddle was changed to a hook to mix the mixture at speed 2 for 2.5 minutes. The dough was proofed for 1.5 hours at 35° C. The dough was then punched down and kneaded for 3 minutes. Proofing occurred for another 1.5 hours at 35° C. The dough was punched down again and kneaded for a further 3 minutes. 100 g of the dough is cut and moulded into shape and flatten in the model. Dough is baked for 22 minutes at 180° C. and baked product is then cooled.

While the present invention is described with respect to particular examples and preferred embodiments, it is understood that the present invention is not limited to these examples and embodiments. In particular, the present invention is not limited to the ingredients listed herein so long as the dough has rice flour, pregelatinised rice starch and optionally modified rice starch are present. Moreover, the present invention is not limited to the processing steps recited herein and may contain additional steps, such as mixing steps, as would be apparent to those skilled in the art depending on what ingredients are used.

The present invention as claimed therefore, includes variations from the particular examples and preferred embodiments described herein, as will be apparent to one of skill in the art.

1. A composition comprising:
(a) a rice flour; and
(b) a pregelatinised rice starch.

2. The composition of claim 1, further comprising a modified rice starch.

3. The composition of claim 1, wherein such composition is gluten-free

4. The composition of 3, further comprising a modified rice starch.

5. The composition of claim 1, wherein wherein the rice flour is present in an amount of about 20% to about 80% by weight.

6. The composition of claim 1, wherein the pregelatinised rice starch is present in an amount of about 10% to about 40% by weight.

7. The composition of claim 2, wherein the modified rice starch is present in an amount of about 5% to about 30% by weight.

8. The composition of claim 1, wherein the rice flour and pregelatinised rice starch are present in an amount of 20% to 80% and 10% to 40% by weight respectively.

9. The composition of claim 2, wherein the rice flour, pregelatinised rice starch and modified rice starch are present in an amount of 20% to 80%, 10% to 40% and 5% to 30% by weight respectively.

10. The composition of claim 1, wherein the rice flour is present in an amount of about 55% to about 65% by weight.

11. The composition of claim 1, wherein the pregelatinised rice starch is present in an amount of about 20% to about 25% by weight.

12. The composition of claim 2, wherein the modified rice starch is present in an amount of about 10% to about 15% by weight.

13. The composition of claim 2, wherein the rice flour, pregelatinised rice starch and modified rice starch are present in an amount of 55% to 65%, 20% to 25% and 10% to 15% by weight. respectively.

14. A dough comprising the composition of claim 1.

15. The dough of claim 14, without the presence of non-rice based flour or starch.

16. The dough of claim 14, further comprising at least one ingredient selected from the group consisting of water, a leavening agent, salt, sugar, icing sugar, eggs, skim milk powder, baking powder, monoglycerides, a fat source and a flavouring.

17. The dough of claim 14, without the presence of a hydrocolloid additive.

18. The dough of claim 16, wherein the leavening agent is a chemical leavening agent.

19. The dough of claim 18, wherein the chemical leavening agent is selected from the group consisting of sodium bicarbonate, monocalcium phosphate (MCP), sodium stearoyl lactylate (SSL) and ammonium bicarbonate.

20. The dough of claim 19, further comprising at least one acid ingredient selected from the group consisting of sodium acid pyrophosphate, monocalcium phosphate monohydrate, monocalcium phosphate anhydrous, sodium aluminium phosphate acidic, dicalcium and phosphate dihyrate.

21. The dough of claim 16, wherein the leavening agent is yeast.

22. The dough of claim 21, wherein the yeast is in the form of dry instant yeast.

23. The dough of claim 22, wherein the dry instant yeast is present in an amount of about 0.87% by weight.

24. The dough of claim 14, wherein the pregelatinised rice starch is modified chemically.

25. The dough of claim 14, wherein the dough is shaped into the form of a bun or a cookie.

26. A method of making a dough comprising the steps of:
(a) combining the composition of claim 1 with water; and
(b) fermenting the dough.

27. The method of claim 26, further comprising the steps of
(a) punching the dough and shaping the dough to form a shaped dough; and
(b) proofing the dough.

28. A method for preparing a baked product comprising baking the dough of claim 14.

29. The method of claim 28, wherein the dough is gluten-free.

30. A dough product prepared by the method of claim 28.

31. A baked product comprising the composition of claim 1.

32. The product of claim 31, further comprising modified rice starch.

33. A baked product prepared from the dough of claim 14.

34. A baked product prepared by the method of claim 26.

35. The baked product of claim 31, wherein the product is selected from the group consisting of a bun, a cookie, a biscuit, a donut, a cracker, a muffin, a cake, a bread and a roll.
